(19) United States
(12) Patent Application Publication
(10) Pub. No.: US 2019/0375987 A1
(43) Pub. Date: Dec. 12, 2019

(54) LIQUID CRYSTAL COMPOSITION AND LIQUID CRYSTAL DISPLAY ELEMENT, LIQUID CRYSTAL DISPLAY

(71) Applicant: Shijiazhuang Chengzhi Yonghua Display Material Co. Ltd., Shijiazhuang City (CN)

(72) Inventors: Zhenqiang LI, Shijiazhuang City (CN); Ke-Lun SHU, Shijiazhuang City (CN); Xiaolong WANG, Shijiazhuang City (CN); Qian ZHANG, Shijiazhuang City (CN); Wenjie WANG, Shijiazhuang City (CN); Yuanyuan LI, Shijiazhuang City (CN)

(21) Appl. No.: 16/239,295

(22) Filed: Jan. 3, 2019

(30) Foreign Application Priority Data
Jun. 8, 2018 (CN) 201810588993.7

(51) Int. Cl. C09K 19/34; C09K 19/30

(52) U.S. Cl. CPC C09K 19/3402; C09K 2019/0466; C09K 19/3003

(57) ABSTRACT

A liquid crystal composition containing one or more compounds of formula I, one or more compounds of formula II, and a compound of formula III. The liquid crystal composition provided in the present invention has a lower viscosity and can achieve a fast response while having a moderate dielectric anisotropy Δε, an appropriate optical anisotropy Δn, and a high stability to heat and light. A liquid crystal display element or liquid crystal display comprising the liquid crystal composition has properties of a wider nematic phase temperature range, a suitable birefringence anisotropy, a very high resistivity, a good ultraviolet resistance, a high charge retention, and a low vapour pressure, etc.

### TECHNICAL FIELD

The present invention relates to the technical field of liquid crystal displays, and specifically relates to a liquid crystal composition, and a liquid crystal display element or a liquid crystal display comprising the liquid crystal composition.

### BACKGROUND ART

In the development of LCDs, liquid crystals for LCDs are currently developing in a direction of a faster response speed and a better reliability, and the high-speed response characteristics of liquid crystal mixtures are derived from the corresponding physical parameters of the components thereof, such as a rotary viscosity γ1, an elastic constant (K), etc., and a high Δn facilitates to reduce the thickness of a liquid crystal cell, thereby improving the response speed, while a high clearing point also facilitates to the combination of mixed crystals. It can be seen therefrom that a desired liquid crystal monomer should have characteristics of a low γ1, an appropriate refractivity, a high clearing point, etc.

In order to achieve the characteristics of a fast response, a high clearing point, a high reliability, a high transmittance, etc., a strategy of introducing a double bond into the molecular structure is used in the selection of a single crystal thus improving the clearing point and ensuring a lower rotary viscosity. When achieving a high-speed response, it is often difficult to achieve a high transmittance, because the increase of a transmittance could result in an increase in rotary viscosity, thereby reducing the respond speed.

### SUMMARY OF THE INVENTION

An object of the present invention is to provide a liquid crystal composition and a liquid crystal display element or liquid crystal display comprising the liquid crystal composition, wherein the liquid crystal composition has a specified diluent liquid crystal compound which provides a lower viscosity and can achieve a fast response; the liquid crystal compound with a high clearing point in the liquid crystal composition provides a high reliability, and the high vertical dielectric liquid crystal compound provides a high transmittance. Meanwhile, it has a moderate dielectric anisotropy Δε, an appropriate optical anisotropy Δn, and high stability to heat and light. The liquid crystal display element or liquid crystal display comprising the liquid crystal composition has properties of a wider nematic phase temperature range, a suitable birefringence anisotropy, a very high resistivity, a good ultraviolet resistance, a high charge retention, and a low vapour pressure, etc.

In order to solve the above technical problems, the present invention provides a liquid crystal composition comprising one or more compounds of formula I, one or more compounds of formula II and a compound of the formula III

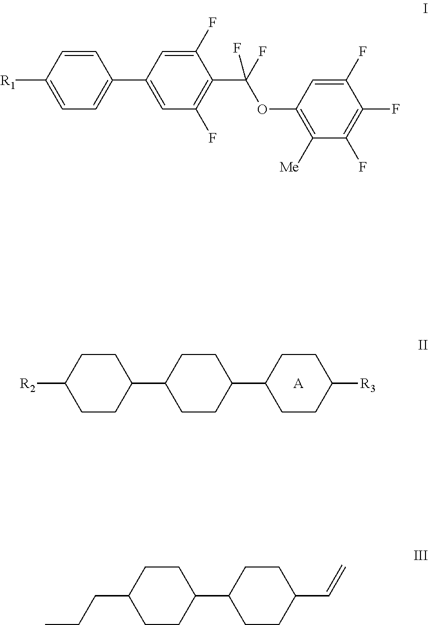

wherein R₁ and R₂ each independently represents an alkyl group having a carbon atom number of 1-10, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenyloxy having a carbon atom number of 3-8, or a fluorine-substituted alkenyloxy having a carbon atom number of 3-8;

R₃ represents F, CF₃, OCF₃, an alkyl group having a carbon atom number of 1-10, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenyloxy having a carbon atom number of 3-8, or a fluorine-substituted alkenyloxy having a carbon atom number of 3-8, and any one or more non-connected CH₂ in the group as represented by R₃ can be substituted by cyclopentyl, cyclobutyl or cyclopropyl;

Me represents methyl;

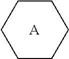

represents phenylene or fluorophenylene.

The liquid crystal composition has characteristics of a high clearing point, a high elastic constant, a high refractivity, a low rotary viscosity, etc.

In such a case, the mass of the one or more compounds of formula I is preferably 1-30%, more preferably 3-15% of the total mass of the liquid crystal composition.

Optionally, said one or more compounds of formula II are preferably one or more of the compounds represented by the following formulas II1-II2,

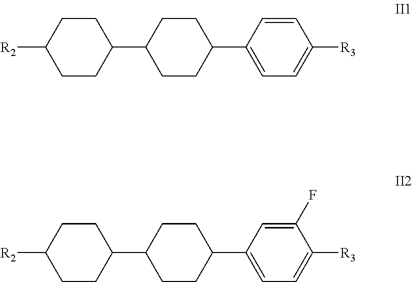

wherein R₂ each independently represents an alkyl group having a carbon atom number of 1-10, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenyloxy having a carbon atom number of 3-8, or a fluorine-substituted alkenyloxy having a carbon atom number of 3-8;

R₃ each independently represents F, CF₃, OCF₃, an alkyl group having a carbon atom number of 1-10, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenyloxy having a carbon atom number of 3-8, or a fluorine-substituted alkenyloxy having a carbon atom number of 3-8, and any one or more non-connected CH₂ in the group represented by R₃ can be substituted by cyclopentyl, cyclobutyl or cyclopropyl.

Optionally, the mass of said one or more compounds of formula II is preferably 1-60%, more preferably 20-45% of the total mass of the liquid crystal composition.

Optionally, the mass of the compound of formula III is preferably 10-55%, more preferably 25-50% of the total mass of the liquid crystal composition.

Optionally, the liquid crystal composition provided in the present invention may further comprises one or more compounds of formula IV

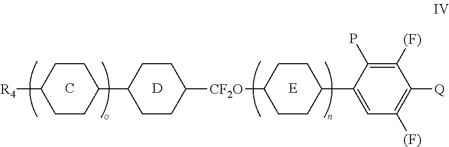

wherein

R₄ represents an alkyl group having a carbon atom number of 1-10, an fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenyloxy having a carbon atom number of 3-8, or a fluorine-substituted alkenyloxy having a carbon atom number of 3-8, and any methylene therein can be replaced by cyclopentyl or cyclopropyl;

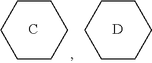

each independently represents one or more of cyclohexylene, cyclohexenylene, phenylene, fluorophenylene and/or groups formed by substituting any one or more unconnected CH₂ in cyclohexylene by oxygen;

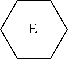

represents phenylene or fluorophenylene;

(F) each independently represents H or F;

o represents 1, 2 or 3;

n represents 1 or 0;

Q represents F, OCF₃, CF₃ or OCF₂H;

P represents methyl or H.

Optionally, the mass of said one or more compounds of formula IV is preferably 1-30% of the total mass of the liquid crystal composition.

Optionally, said one or more compounds of formula IV preferably are one or more of the compounds represented by the following formulas IV1-IV15

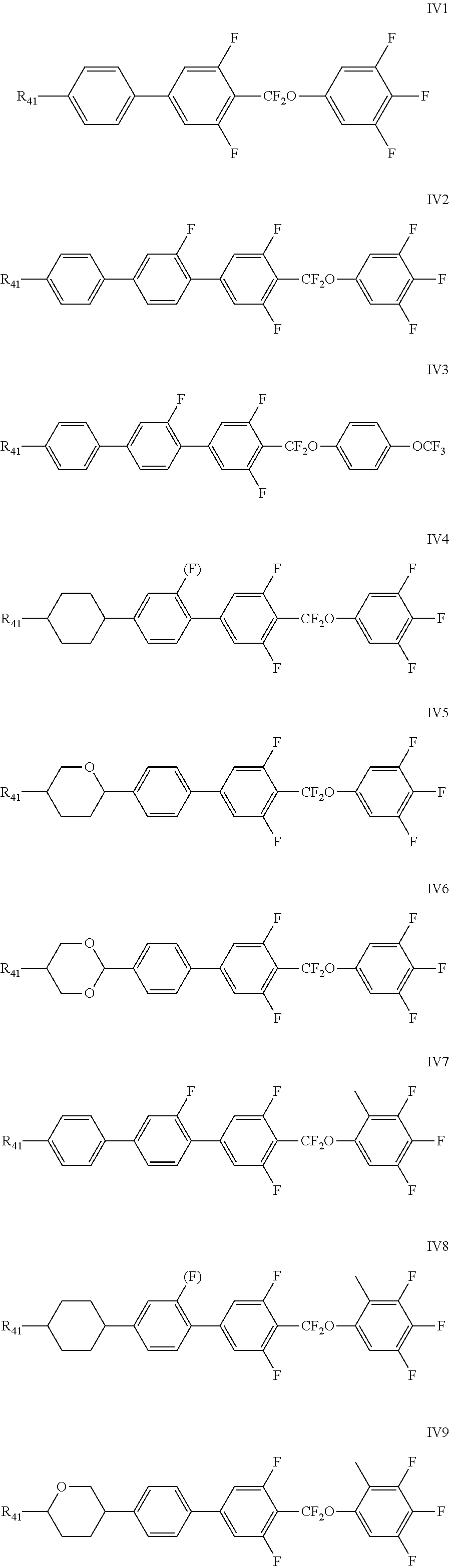

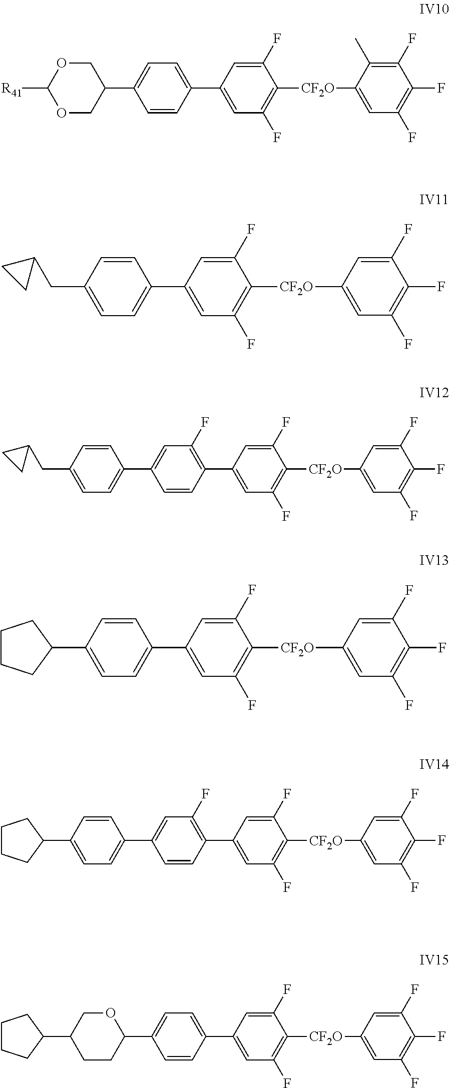

wherein R₄₁ each independently represents a linear alkyl having a carbon atom number of 1-5;

(F) each independently represents H or F.

Optionally, said liquid crystal composition may further comprises one or more compounds of formula V

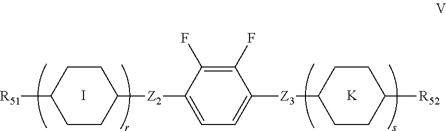

wherein

R₅₁ and R₅₂ each independently represents an alkyl group having a carbon atom number of 1-10, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenyloxy having a carbon atom number of 3-8, or a fluorine-substituted alkenyloxy having a carbon atom number of 3-8, and any methylene therein can be replaced by cyclopentyl or cyclopropyl;

r represents 1 or 2;

s represents 0, 1 or 2;

Z₂ and Z₃ each independently represents a single bond, —COO—, —CH₂O— or CH₂CH₂—;

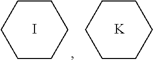

each independently represents one or more of cyclohexylene, cyclohexenylene, phenylene and/or fluorophenylene.

Optionally, the mass of said one or more compounds of formula V is preferably 10-25% of the total mass of the liquid crystal composition.

Optionally, said one or more compounds of the formula V preferably are one or more of the compounds represented by the following formulas V1-V11

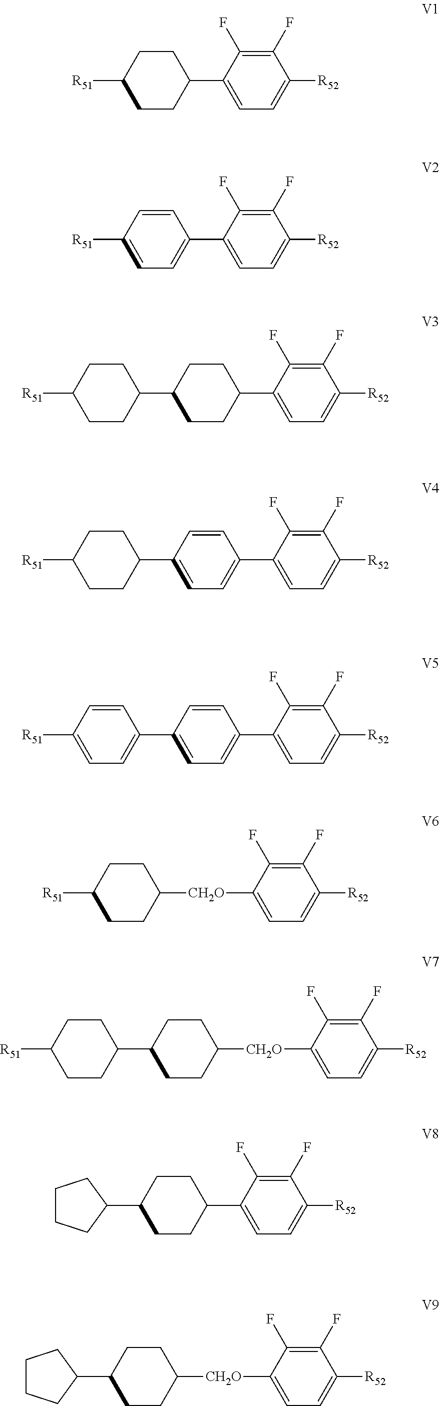

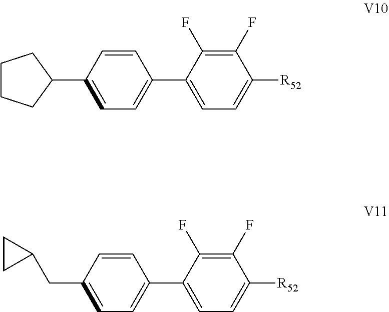

wherein, R₅₁ and R₅₂ each independently represents an alkyl group having a carbon atom number of 1-10, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenyloxy having a carbon atom number of 3-8, or a fluorine-substituted alkenyloxy having a carbon atom number of 3-8.

In the liquid crystal display, in order to achieve a higher transmittance, there are some requirements for the vertical dielectric property. The addition of the compounds represented by formula V into the liquid crystal composition provided in the present invention can adjust the vertical dielectric property of the mixture as needed; a preferred liquid crystal composition can maintain a low rotary viscosity to further improve the transmittance of the liquid crystal material on the premise of the sacrifice of a small amount of the response speed.

The present invention also relates to a liquid crystal display element or a liquid crystal display comprising any one of the above liquid crystal compositions; said display element or display is an active matrix display element or display, or a passive matrix display element or display.

Optionally, said liquid crystal display element or the liquid crystal display is preferably an active matrix addressed liquid crystal display element or liquid crystal display.

Optionally, said active matrix display element or display is specifically a TN-TFT or IPS-TFT liquid crystal display element or display.

Due to the use of the above technical solutions, the technical progress achieved by the present invention are:

in the present invention, by means of the match of the liquid crystal mixture, the clearing point is improved while the reliability is increased, moreover, the rotary viscosity is controlled at a lower level; by combining with the introduction of negative monomers, the vertical dielectric property is improved while minimizing the sacrifice of the rotational viscosity. In the present invention, the display speed and reliability and the high transmittance of the liquid crystal will be greatly improved.

The liquid crystal display element or the liquid crystal display provided in the present invention has properties of a wider nematic phase temperature range, a suitable birefringence anisotropy, a high resistivity, a good ultraviolet resistance, a high charge retention, and a low vapour pressure, etc.

### DETAILED DESCRIPTION OF EMBODIMENTS

The present invention is further illustrated by combining the following specific examples, but the present invention is not limited to the following examples. The liquid crystal composition of the present invention can be produced by a method by mixing liquid crystal compounds, such as a method of mixing different components at a high temperature and dissolving each other, and the liquid crystal composition of the present invention can also be prepared according to other conventional preparation methods such as heating, ultrasonic processing, suspending, etc.

The methods are all conventional methods, unless otherwise specified.

The raw materials can be obtained from public commercial routes, unless otherwise specified.

The percentages are all percentages by mass, unless otherwise specified.

The temperature is degree centigrade (° C.), and the specific meanings and test conditions of other symbols are as follows:

Cp represents a liquid crystal clearing point (° C.), as tested by the DSC quantitative method;

S—N represents a melting point (° C.) from a crystalline state to a nematic phase of the liquid crystal;

Δn represents an optical anisotropy, Δn=nₑ−nₒ, nₒ is the refractivity of an ordinary light, nₑ is the refractivity of an extraordinary light, and test conditions are 25±2° C., 589 nm, an Abbe refractometer test;

Δε represents a dielectric anisotropy, Δε=ε//−ε⊥, wherein ε// is a dielectric constant parallel to the molecular axis, and ε⊥ is a dielectric constant perpendicular to the molecular axis, and the test conditions are 25±0.5° C., a 20 microns parallel cell, an INSTEC: ALCT-IR1 test;

γ1 represents a rotary viscosity (mPa·s), and the test conditions are 25±0.5° C., a 20 microns parallel cell, an INSTEC: ALCT-IR1 test;

ρ represents a resistivity (δ·cm), the test condition is 25±2° C., and the test instruments are a TOYO SR6517 high resistance meter and LE-21 liquid electrodes.

VHR represents a voltage holding ratio (%), and test conditions are 20±2° C., a voltage of ±5 V, a pulse width of 10 ms, and a voltage holding time of 16.7 ms. The test apparatus is a TOYO Model6254 liquid crystal performance comprehensive tester.

τ represents a response time (ms), the test instrument is DMS-501, the test condition is 25±0.5° C., the test cell is a 3.3 microns IPS test cell, the electrode spacing and the electrode width are both 10 microns, and the angle between the rubbing direction and the electrode is 10°.

T (%) represents a transmittance, T (%)=100%*bright state (Vop) luminance/light source luminance, the test apparatus is DMS501, the test condition is 25±0.5° C., the test cell is a 3.3 microns IPS test cell, the electrode spacing and the electrode width are both 10 microns, the angle between the rubbing direction and the electrode is 10°

In the examples of the present invention application, liquid crystal monomer structures are represented by codes, wherein the code representation methods of cyclic structures, end groups and linking groups of the liquid crystals are shown in tables (I) and (II) below

TABLE (I)
Corresponding codes for cyclic structures

| Cyclic structures | Corresponding codes |
|---|---|
| 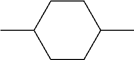 | C |
| 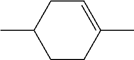 | L |
| 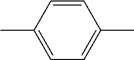 | P |
| 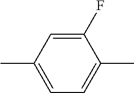 | G |
| 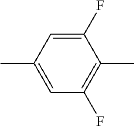 | U |
| 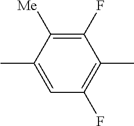 | K |
| 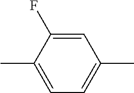 | Gi |
| 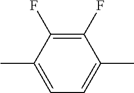 | Y |
| 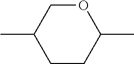 | A |
| 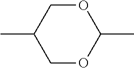 | D |

TABLE (II)
Corresponding codes for end groups and linking groups

| End groups and linking groups | Corresponding codes |
|---|---|
| CnH2n+1— | n- |
| CnH2n+1O— | nO— |
| —OCF₃ | —OT |
| —CF₂O— | Q |
| —O4₂O— | O |
| —F | —F |
| —CN | —N |
| —CH2CH2— | —E— |
| —CH═CH— | —V— |
| —C≡C— | T |
| —COO— | Z |
| —CH═CH—CnH2n+1 | Vn- |
| 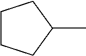 | Cp |
| 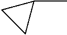 | Cpr |
| —CH═CF2 | —V(F,F) |

### EXAMPLE

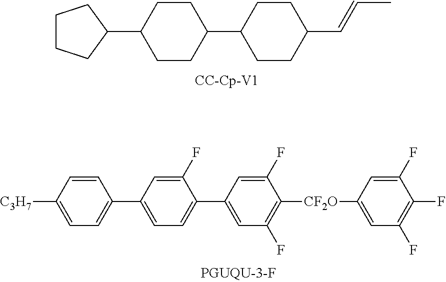

### Example 1

| Category | Liquid crystal monomer code | Content (%) |
|---|---|---|
| I | PUQK-3-F | 10 |
| II | CCG-V-F | 10 |
| II | CCP-V-1 | 10 |
| II | CCP-V2-1 | 10 |
| III | CC-3-V | 40 |
| IV | PGUQK-3-F | 6 |
| | PGP-3-2 | 5 |
| | PP-3-O2 | 9 |

Δε[1 KHz, 20° C.]: 4.9
ε⊥[1 KHz, 20° C.]: 3.2
Δn[589 nm, 20° C.]: 0.1024
Cp: 75° C.
γ₁: 49 mPa · s.

### Example 2

| Category | Liquid crystal monomer code | Content (%) |
|---|---|---|
| I | PUQK-4-F | 5 |
| II | CCG-V(F,F)-F | 15 |
| II | CCP-V(F,F)-1 | 18 |
| II | CCP-V(F,F)2-1 | 10 |
| III | CC-3-V | 37 |
| IV | PGUQK-3-F | 6 |
| | PPGU-Cp-F | 2 |
| | PP-3-1 | 7 |

Δε[1 KHz, 20° C.]: 4.3
ε⊥[1 KHz, 20° C.]: 3.0
Δn[589 nm, 20° C.]: 0.0960
Cp: 84° C.
γ1: 53 mPa · s.

### Example 3

| Category | Liquid crystal monomer code | Content (%) |
|---|---|---|
| I | PUQK-2-F | 2 |
| II | CCG-V(F,F)-F | 15 |
| II | CCG-V-OT | 10 |
| II | CCP-1V-1 | 20 |
| II | CCP-V2-2 | 10 |
| III | CC-3-V | 25 |
| IV | PGUQK-3-F | 6 |
| | PPGU-3-F | 2 |
| | PP-3-1 | 10 |

Δε[1 KHz, 20° C.]: 4
E⊥[1 KHz, 20° C.]: 2.9
Δn[589 nm, 20° C.]: 0.1034
Cp: 94° C.
γ1: 61 mPa · s.

### Example 4

| Category | Liquid crystal monomer code | Content (%) |
|---|---|---|
| I | PUQK-3-F | 20 |
| II | CCG-3-F | 15 |
| II | CCG-3-OT | 10 |
| II | CCP-V-1 | 20 |
| II | CCP-V2-1 | 10 |
| III | CC-3-V | 25 |

Δε[1 KHz, 20° C.]: 6.3
ε⊥[1 KHz, 20° C.]: 3.4
Δn[589 nm, 20° C.]: 0.0922
Cp: 86.4° C.
γ1: 62 mPa · s.

### Example 5

| Category | Liquid crystal monomer code | Content (%) |
|---|---|---|
| I | PUQK-3-F | 30 |
| II | CCG-3-F | 15 |
| II | CCG-3-OT | 15 |
| II | CCP-V-1 | 20 |
| II | CCP-V2-1 | 10 |
| III | CC-3-V | 10 |

Δε[1 KHz, 20° C.]: 9
ε⊥[1 KHz, 20° C.]: 3.8
Δn[589 nm, 20° C.]: 0.1037
Cp: 87° C.
γ1: 73 mPa · s.

### Example 6

| Category | Liquid crystal monomer code | Content (%) |
|---|---|---|
| I | PUQK-3-F | 25 |
| II | CCG-V-F | 15 |
| II | CCG-V-OT | 15 |
| II | CCP-V-1 | 20 |
| II | CCP-V2-1 | 10 |
| III | CC-3-V | 10 |
| V | CY-3-O2 | 5 |

Δε[1 KHz, 20° C.]: 7.5
ε⊥[1 KHz, 20° C.]: 4.1
Δn[589 nm, 20° C.]: 0.1006
Cp: 86° C.
γ1: 73 mPa · s.

### Example 7

| Category | Liquid crystal monomer code | Content (%) |
|---|---|---|
| I | PUQK-3-F | 25 |
| II | CCG-V-F | 15 |
| II | CCG-V-OT | 15 |
| II | CCP-V-1 | 20 |
| II | CCP-V2-1 | 10 |
| III | CC-3-V | 10 |
| V | CY-3-O2 | 5 |
| V | CCY-3-O2 | 10 |
| V | CPY-3-O2 | 5 |

Δε[1 KHz, 20° C.]: 4.1
ε⊥[1 KHz, 20° C.]: 4.8
Δn[589 nm, 20° C.]: 0.1023
Cp: 102° C.
γ1: 103 mPa · s.

### Example 8

| Category | Liquid crystal monomer code | Content (%) |
|---|---|---|
| I | PUQK-3-F | 16 |
| II | CCG-V-F | 15 |
| II | CCG-V-OT | 15 |
| II | CCP-V-1 | 10 |
| II | CCP-V2-1 | 10 |
| III | CC-3-V | 10 |
| V | PY-3-O2 | 10.5 |
| V | CCY-3-O2 | 5 |
| V | CPY-3-O2 | 7.5 |
| IV | PGUQK-3-F | 1 |

Δε[1 KHz, 20° C.]: 4.5
ε⊥[1 KHz, 20° C.]: 5.3
Δn[589 nm, 20° C.]: 0.11
Cp: 91° C.
γ1: 89 mPa · s.

### Example 9

| Category | Liquid crystal monomer code | Content (%) |
|---|---|---|
| I | PUQK-3-F | 5 |
| II | CCG-V-F | 10 |
| II | CCG-V-OT | 10 |
| II | CCP-V-1 | 10 |
| II | CCP-V2-1 | 10 |
| III | CC-3-V | 10 |
| V | PY-3-O2 | 10 |
| V | CCY-3-O2 | 5 |
| V | CPY-3-O2 | 5 |
| IV | PGUQK-3-F | 10 |
| IV | APUQK-3-F | 15 |

Δε[1 KHz, 20° C.]: 8.4
ε⊥[1 KHz, 20° C.]: 5.3
Δn[589 nm, 20° C.]: 0.1159
Cp: 104° C.
γ1: 122 mPa · s.

### Comparative Example 1

| Category | Liquid crystal monomer code | Content (%) |
|---|---|---|
| I | PUQK-3-F | 10 |
| II | CCG-V-F | 10 |
| II | CCP-V-1 | 10 |
| II | CCP-V2-1 | 10 |
| | CC-4-V | 40 |
| IV | PGUQK-3-F | 6 |
| | PGP-3-2 | 5 |
| | PP-3-O2 | 9 |

Δε[1 KHz, 20° C.]: 4.6
ε⊥[1 KHz, 20° C.]: 3.2
Δn[589 nm, 20° C.]: 0.1024
Cp: 73° C.
γ₁: 54 mPa · s.

Comparing Example 1 with Comparative Example 1, after CC-3-V is replaced with CC-4-V in the formulation, the viscosity is increased from 49 mPa·s to 54 mPa·s, which would lead to a 10% decrease in response speed. Meanwhile, the dielectric value is decreased from 4.9 to 4.6, with a decreasing extend of 6%, which will lead to an increased driving voltage and an increased power consumption of the liquid crystal device. The clearing point is reduced from 75° C. to 73° C., leading to a reduced reliability. Therefore, the use of CC-4-V leads to a comprehensive reduction in performance.

### Comparative Example 2

| Category | Liquid crystal monomer code | Content (%) |
|---|---|---|
| | CPP-3-2 | 5 |
| | CPP-5-2 | 4 |
| | CC-3-V1 | 10 |
| | CC-4-V | 51 |
| IV | PGUQK-3-F | 6 |
| IV | PGUQK-4-F | 6 |
| IV | PGUQK-5-F | 5 |
| | PGP-3-2 | 5 |
| | PP-3-O2 | 8 |

Δε[1 KHz, 20° C.]: 4.9
ε⊥[1 KHz, 20° C.]: 2.9
Δn[589 nm, 20° C.]: 0.1025
Cp: 69° C.
γ₁: 48 mPa · s.

Comparing with Example 1, Comparative Example 2 does not contain a compound of formula I and a compound of formula II. Replacing the compound of formula I with PGUQK-n-F provides a dielectric anisotropy Δε of the liquid crystal composition, replacing the compound of formula II with CPP-n-m provides a clearing point Cp, and the compounds of formula III is replaced with CC-4-V. The refractivity Δn and the dielectric anisotropy Δε of the liquid crystal composition of Comparative Example 2 remains the same as those in Example 1. The clearing point Cp of Comparative Example 2 is lower than that of Example 1 by 6° C., which would significantly reduce the reliability and operating temperature range of the liquid crystal composition; the vertical dielectric value of Comparative Example 2 is 2.9, which is lower than the vertical dielectric value 3.2 of Example 1, and the decreasing extent is up to 10%, and which would reduce the transmittance of Comparative Example 2.

Therefore, by the comparison of Examples 1-9 with Comparative Examples 1-2, it can be understood that the liquid crystal composition of the examples of the present invention has a lower viscosity, can achieve a fast response, and has a moderate dielectric anisotropy Δε, a moderate optical anisotropy Δn, high stability to heat and light, a better transmittance and high reliability. The liquid crystal material comprising the liquid crystal composition provided in the present invention not only has good chemical and thermal stability and stability to an electric field and an electromagnetic radiation, but also has properties of a wider nematic phase temperature range, a suitable birefringence anisotropy, a very high resistivity, a good UV resistance, a high charge retention, and a low vapor pressure, etc., as a liquid crystal materials for thin film transistor technology (TFT-LCD). By improving the clearing point of the liquid crystal composition, the reliability of the liquid crystal composition is improved, and the rotary viscosity is controlled at a lower level, and by the combination with the introduction of negative monomers, the vertical dielectric property is improved while minimizing the sacrifice of rotary viscosity. The present invention will greatly improve the display speed, reliability and transmittance of the liquid crystal compositions and liquid crystal display devices.

1. A liquid crystal composition, containing one or more compounds of formula I, one or more compounds of formula II, and a compound of formula III 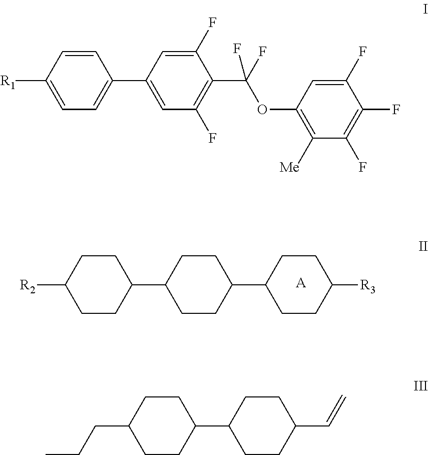
wherein R₁ and R₂ each independently represents an alkyl group having a carbon atom number of 1-10, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenyloxy having a carbon atom number of 3-8, or a fluorine-substituted alkenyloxy having a carbon atom number of 3-8;
R₃ represents F, CF₃, OCF₃, an alkyl group having a carbon atom number of 1-10, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenyloxy having a carbon atom number of 3-8, or a fluorine-substituted alkenyloxy having a carbon atom number of 3-8, and any one or more non-connected CH₂ in the group as represented by R₃ can be substituted by cyclopentyl, cyclobutyl or cyclopropyl;
Me represents methyl; 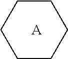
represents phenylene or fluorophenylene.

2. The liquid crystal composition according to claim 1, wherein
said one or more compounds of formula II are one or more of the compounds represented by the following formulas II1-II2 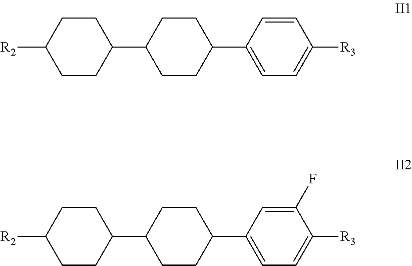
wherein R₂ each independently represents an alkyl group having a carbon atom number of 1-10, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenyloxy having a carbon atom number of 3-8, or a fluorine-substituted alkenyloxy having a carbon atom number of 3-8;
R₃ each independently represents F, CF₃, OCF₃, an alkyl group having a carbon atom number of 1-10, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenyloxy having a carbon atom number of 3-8, or a fluorine-substituted alkenyloxy having a carbon atom number of 3-8, and any one or more non-connected CH₂ in the group represented by R₃ can be substituted by cyclopentyl, cyclobutyl or cyclopropyl.

3. The liquid crystal composition according to claim 1, wherein said liquid crystal composition further comprises one or more compounds of formula IV 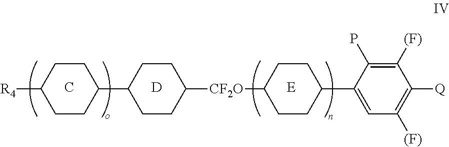
wherein
R₄ represents an alkyl group having a carbon atom number of 1-10, an fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenyloxy having a carbon atom number of 3-8, or a fluorine-substituted alkenyloxy having a carbon atom number of 3-8, and any methylene therein can be replaced by cyclopentyl or cyclopropyl; 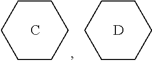
each independently represents one or more of cyclohexylene, cyclohexenylene, phenylene, fluorophenylene and/or groups formed by substituting any one or more unconnected CH₂ in cyclohexylene by oxygen; 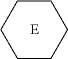
represents phenylene or fluorophenylene;
(F) each independently represents H or F;
o represents 1, 2 or 3;
n represents 1 or 0;
Q represents F, OCF₃, CF₃ or OCF₂H;
P represents methyl or H.

4. The liquid crystal composition according to claim 3, wherein said one or more compounds of formula IV are one or more of the compounds represented by the following formulas IV1-IV15 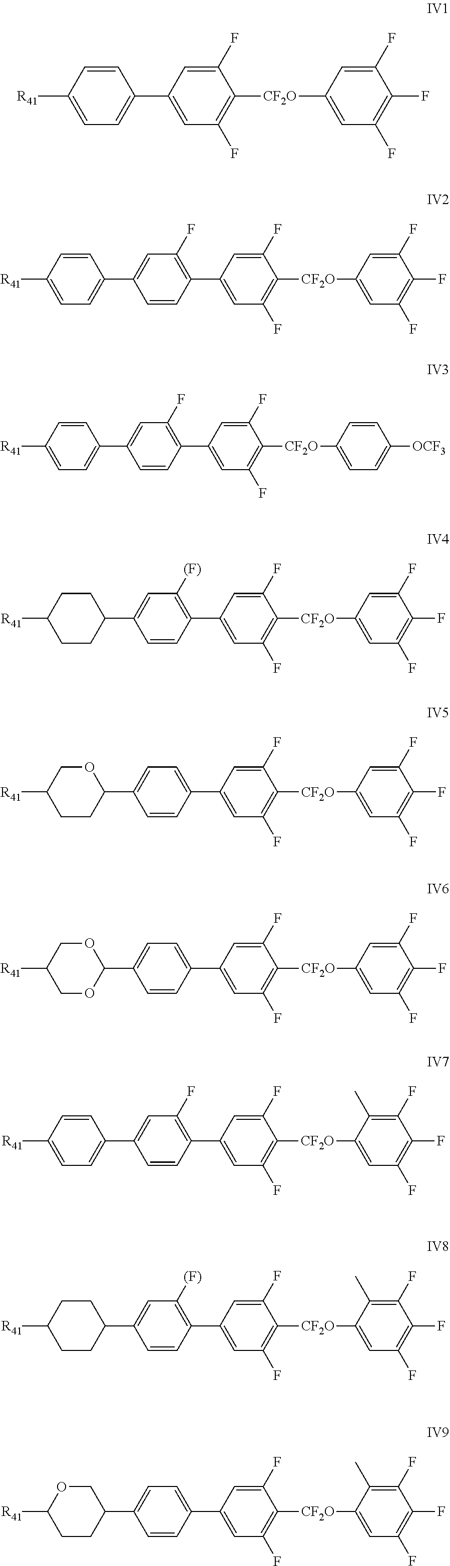 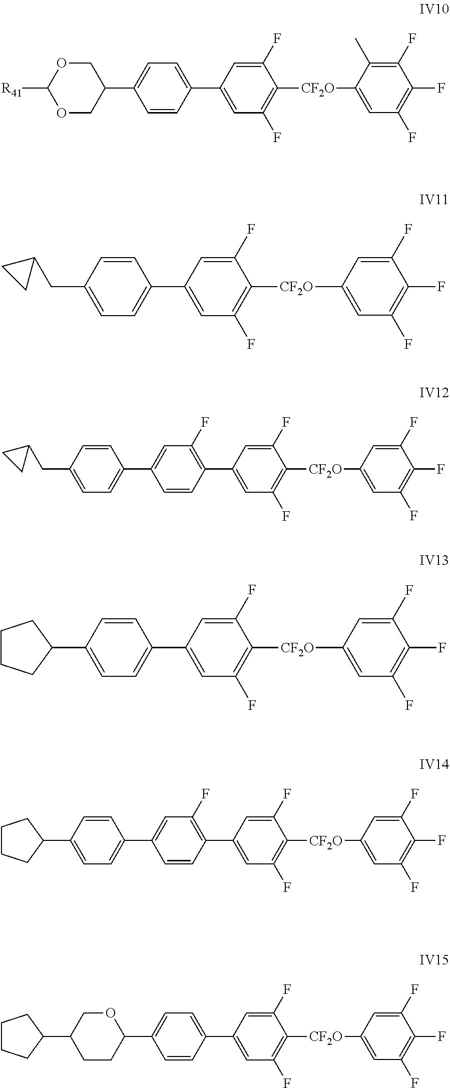
wherein R₄₁ each independently represents a linear alkyl having a carbon atom number of 1-5;
(F) each independently represents H or F.

5. The liquid crystal composition according to claim 1, wherein said liquid crystal composition further comprises one or more compounds of formula V 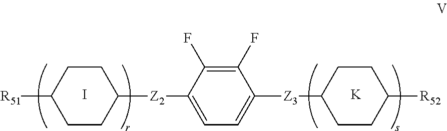
wherein
R₅₁ and R₅₂ each independently represents an alkyl group having a carbon atom number of 1-10, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenyloxy having a carbon atom number of 3-8, or a fluorine-substituted alkenyloxy having a carbon atom number of 3-8, and any methylene therein can be replaced by cyclopentyl or cyclopropyl;
r represents 1 or 2;
s represents 0, 1 or 2;
Z₂ and Z₃ each independently represents a single bond, —COO—, —CH₂O— or CH₂CH₂—; 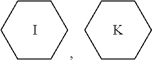
each independently represents one or more of cyclohexylene, cyclohexenylene, phenylene and/or fluorophenylene.

6. The liquid crystal composition according to claim 5, wherein said one or more compounds of formula V are one or more of the compounds represented by the following formulas V1-V11 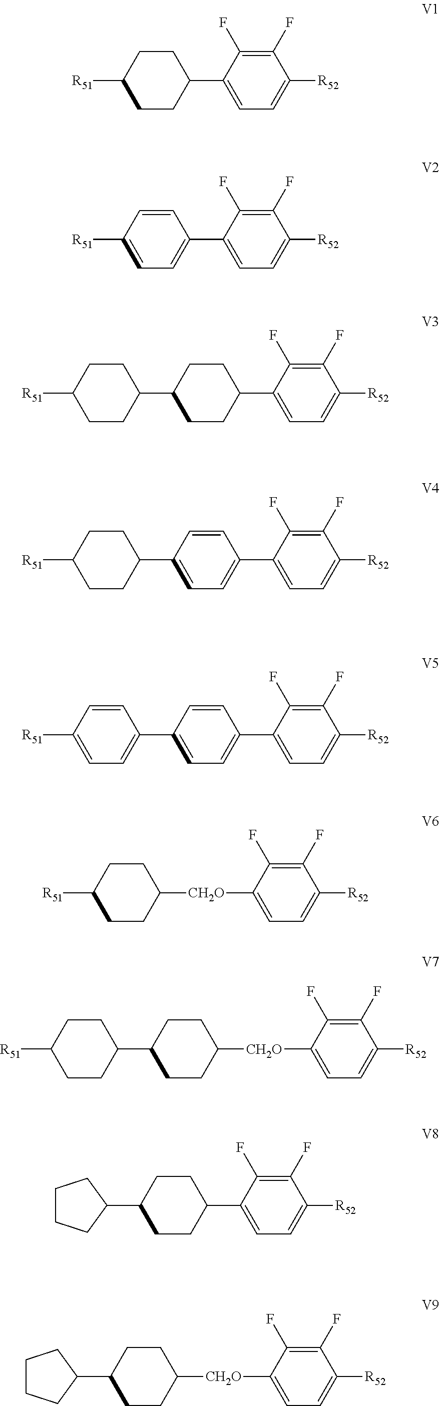 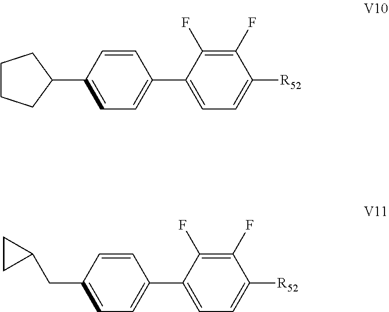
wherein, R₅₁ and R₅₂ each independently represents an alkyl group having a carbon atom number of 1-10, a fluorine-substituted alkyl group having a carbon atom number of 1-10, an alkoxy group having a carbon atom number of 1-10, a fluorine-substituted alkoxy group having a carbon atom number of 1-10, an alkenyl group having a carbon atom number of 2-10, a fluorine-substituted alkenyl group having a carbon atom number of 2-10, an alkenyloxy having a carbon atom number of 3-8, or a fluorine-substituted alkenyloxy having a carbon atom number of 3-8.

7. A liquid crystal display element or liquid crystal display, comprising the liquid crystal composition of claim 1, wherein said display element or display is an active matrix display element or display, or a passive matrix display element or display.
